(19) United States
(12) Patent Application Publication
(10) Pub. No.: US 2017/0330221 A1
(43) Pub. Date: Nov. 16, 2017

(54) SYSTEMS AND METHODS FOR INTEGRATION OF UNIVERSAL MARKETING ACTIVITIES

(71) Applicants: Saeed R. Bagheri, New York City, NY (US); Seyed Hanif Mahboobi, New York City, NY (US); Joong Bum Rhim, New York City, NY (US)

(72) Inventors: Saeed R. Bagheri, New York City, NY (US); Seyed Hanif Mahboobi, New York City, NY (US); Joong Bum Rhim, New York City, NY (US)

(21) Appl. No.: 15/153,728

(22) Filed: May 12, 2016

(51) Int. Cl. G06Q 30/02; G06F 17/30

(52) U.S. Cl. CPC G06Q 30/0246; G06F 17/30598

(57) ABSTRACT

A system integrates activity data and includes a processor to obtain a plurality of activity data of consumer data points with data channels from different data sources. The obtained plurality of activity data includes non-uniformed data formats and with data properties based on a plurality of data property definitions. A set of data buckets is determined, and the processor further classifies each of the plurality of activity data into the determined data buckets. The processor further reorganizes each of the plurality of activity data. The processor further stitches the plurality of activity data in the determined set of data buckets. The system further includes the processor to create a unified marketing interaction table (UMIT) for analysis on the data properties of the stitched plurality of activity data.

### BACKGROUND

Analysis, simulation, and optimization of marketing campaigns has attracted significant interest recently. Due to rapidly growing use of multi-channel advertising, advertising performance measurement and marketing modeling or optimization require unified dataset across all marketing channels. The scope and complexity of the market model is rapidly growing thanks to the availability of large and versatile datasets. For example, a proper market analysis model (e.g. attribution model and marketing mix model) heavily depends on the availability of data points from multiple sources (or channels). Although multi-channel marketing is an established practice, multi-channel models have been always a challenge to implement and therefore practitioners have to use basic approximate and often inaccurate methods to co-join data. The fundamental issue in multi-channel market modeling and analysis lies in the heterogeneity of data format available from different resources.

While one may have the details of users' interaction with digital advertising channels, most of other channels can only provide aggregated data. On the other hand, user-level datasets may also be available from different resources (e.g. desktop and mobile ad impressions), but one cannot integrate these resources due to the absence of a unified user identification scheme. Although there has been some development regarding cross-channel market models using aggregated levels data, a universal user-level cross-channel model has not been developed at scale until embodiments of the invention. Few existing user-level multichannel models utilize panelist and they operate at scale of less than 0.1% of population. Therefore, they are not a proper representation of the whole market. Aspects of the invention propose a system and method for integration of marketing interaction data from multiple channels at scale.

Of course, gathering data from different data sources have been attempted. For example, prior attempts have been made by gathering data from different media types (digital, TV, mobile, etc.). The gathered data is next integrated in a single dataset. This model has been used to allocate marketing resources, but unfortunately, not much details can be provided regarding the user matching across different channel sources.

Separately, others have proposed to study customer segmentations in customer interactions. These customer segments may be used to target them based on the likelihood to buy a certain product. A multi-dimensional segmentation approach may be used to group similar customers together. Clustering algorithms may be used to identify similar customer segments.

Here are some prior claims for methods to integrate data or to segment users but not to do both. The integration does not include user matching across different channels. Furthermore, the segmentation is only for selecting proper target of advertising. For example, some prior art specifically teaches segmentation for customizing model according to each segment. That is, they apply different model for different segment.

### SUMMARY

According to aspects of the invention, segmentation is applied to combine data with known demographic information and data with unknown demographic information. Hence, each segment is a data point and embodiments of the invention apply all segments to one model. Embodiments of the invention improve data organization technologies through the creation and building of a Unified Marketing Interaction Table (UMIT), a two-dimensional structure, that is capable of capturing multi-facet or multi-dimensional nature of data for marketing or advertising. By building an unconventional two-dimensional structure to represent multi-facet or multi-dimensional data source, aspects of the invention improve functionality of computing devices and improve efficiencies in searching and organizing multi-facet or multi-dimensional data. Moreover, while the exemplary use of aspects of invention as described herein relates to marketing data, it is to be understood that application of embodiments of the invention may be on other areas.

In addition, embodiments of the invention generally improve functionality and efficiency of the computer-rooted technologies. Using the following analogy as an illustration, the clarity or sharpness of displayed images on a display screen hardware device is typically limited by the hardware components of the device, i.e., its aspect ratio and resolution related capabilities. However, this does not prohibit computer-rooted techniques to improve processing of the ways how images are displayed, such as half-toning on a pixel-by-pixel level etc., on the display hardware. The improved outcome gives users sharper or more vivid images without the need to replace existing hardware.

Aspects of the invention are similar in that approach because embodiments of the invention improve more efficient processing or fine-tuning of multi-facet data from data sources with various data formats by enabling applications to expose data properties through rich data organizations.

[More to be inserted after final set of claims is approved].

### BRIEF DESCRIPTION OF THE DRAWINGS

FIG. 1 is a flowchart depicting the entire steps of the marketing data integration system according to one embodiment of the invention.

FIG. 2 is a schematic illustration of unifying the format of data with different granularity according to one embodiment of the invention.

FIG. 3 is a flowchart that illustrates an exemplary marketing data integration system according to one embodiment of the invention.

FIG. 4 is a diagram illustrating the concept of timing unification for multiple data sources according to one embodiment of the invention.

FIG. 5 is a flowchart depicting the entire steps of measurement and activation using this system and method for integration of universal marketing activities.

FIG. 6 is an exemplary system diagram illustrating a computing system environment according to one embodiment of the invention.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

Advertisements are used to promote a product or a company to consumers and ultimately to bring up sales. They are delivered to consumers through plurality of channels like television, newspaper, and online display, which play an interactive role to raise consumers' awareness, interest, and purchase. Even though most of the advertisement data is available across multiple channels, their advertising effects are hardly analyzed together. This is because, first, the data from each channel comes in a different format as well as a different level of details, and second, it is not possible to identify individual consumers from the data for privacy protection. Despite these challenges, the need for multi-channel analysis is crucial for advertisers to accurately forecast the output of advertising plans and to optimize the budget allocated across the plurality of channels. Hence, aspects of the invention attempt to integrate the data with different format from multiple channels and create a dataset with unified format for the multi-channel analyses. In addition, it is to be understood different computing systems, sometimes dedicated computing systems executing specially tailored process-executable instructions may be employed to process and analyzed the data collected.

The system and method embodiments of the invention described herein include the steps of integration of raw data files into the unified dataset by generating a Unified Marketing Interaction Table (UMIT). In this example, a data unit or a bucket (hereinafter collective referred to as “bucket” for the sake of convenience and not as a limitation), which may be defined as a set of consumers with common attributes, is the key and differentiating aspect of this system and method. In one example, this bucket enables connection of marketing activities for the consumers in multiple channels even without knowing identity of the consumers. In addition, the bucket may be flexibly defined so as to deal with the difference in data granularity level of data sources. As such, through this intelligent use of the bucket, embodiments of the invention improve the data manipulation when run on a computing device.

In another embodiment, systems and methods described here address several typical data formats and their transformation for the integration. In other words, systems and methods transform data from different levels and generate another format or structural unit so that the generated or created format may be more efficiently consumed or processed. Additionally, the system and method of embodiments of the invention are universal so that they may handle unspecified or new data formats as well. Aspects of the invention include forming common buckets amongst all channels (e.g., data source channels), converting the data into bucket level, and correlating/stitching data across the channels.

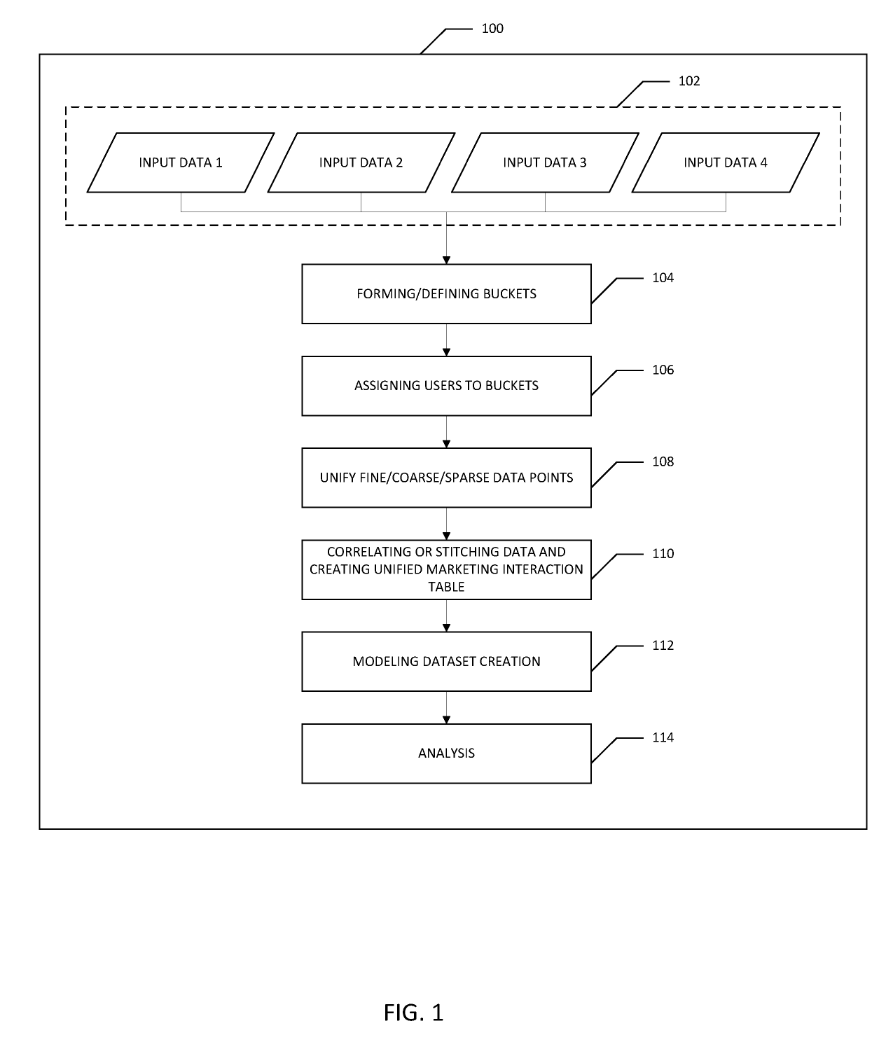

FIG. 1 is a flowchart depicting the steps of the marketing data integration system 100 according to one embodiment of the invention. It receives input data from multiple sources (block 102). For example, block 102 shows input data 1, input data 2, input data 3, and input data 4. It is to be understood that the number of input sources are for illustration purposes only. The data source may include consumer panel data of television watching and television advertising schedule, event-level data of online display/paid search ad impression, mobile phone-based location data, and billboard deployment data. It is to be understood that other types of data from other sources maybe available to be received by a system of embodiments of the invention without departing from the scope or spirit of the invention.

Still referring to FIG. 1, this input process may be automatically performed by connection between data providers and analytics platform (e.g., via Application Programming Interface (API)) or manually performed). The input process further includes selecting and pulling out desired data from the collected or gathered data source. For example, files with marketing data may be scanned, parsed, or through other suitable approaches to retrieve and recognize relevant marketing data for the market data integration system described according to one embodiment of the invention. Within this process, data integrity check and any other necessary pre-processing of the collected data may be done in this step as well.

Still referring to FIG. 1, definitions of buckets (block 104) take into account the granularity level difference in the input datasets (block 102), the analysis requirement of the data and confidence level of accuracy, and/or client's request. In one embodiment, buckets are defined by at least the following factors, categories, or classifications: consumers' demographic attributes, including but not limited to age, gender, ethnicity, annual income, the size of household, education level, and designated market area (DMA). The size of a bucket, which may be the number of people in the bucket, is flexible. For example, the size of the bucket varies from one person to the entire population depending on the scale of the dimensions of the buckets. For example, the dimensions may be one expression of a finer subset of a given data set.

In one example, an advertiser may want to analyze their marketing outcomes in terms of buckets defined by ten age levels, two gender levels, five ethnicity levels, five annual income levels, six household size level, and fifty DMA level for a country whose population is about 100 million people. Then, aspects of the invention provide for 150,000 (=10×2×5×5×6×50) buckets of average size of 666 people to be defined. In another example, buckets may be defined only by two DMA levels, which creates two huge buckets containing approximately 50 million people each. Buckets may be defined or scaled to be mutually disjoint—intersection of any two buckets is empty—but they need not be a partition of the entire people. In addition, as mentioned above, the bucket definitions may be defined by a client.

In one embodiment, buckets defined in block 104 are stored in data storage units. For example, buckets may be stored in databases, electronic storage drives, etc., such that data therein may be accessible either by wired or wireless means.

Still referring to FIG. 1, when consumers are classified into the defined buckets (block 106), they may be classified with 100% accuracy or less (deterministic vs. probabilistic). In one embodiment, the accuracy of the classification may mean the probability of a person belonging to the assigned bucket. An example of deterministic classification is the consumer panel. In this example, a panel is a group of selected people who agree to take part in surveys or to install a device that monitors their media consumption. The panelists who have revealed their demographic information may be classified into a bucket deterministically with 100% accuracy. For some consumers whose required information (e.g., demographic information) is unknown or partially known, profiling or statistical presumptions may be needed ahead of their bucket assignment or generation.

In one embodiment, the profiling may be done by a statistical inference method that measures the similarity between the unknown consumer and known panelists.

Based on the precision of the method and availability of information, the accuracy of each consumer's assignment may be calculated. In one example, the bigger the buckets—and the fewer the buckets—, the higher the accuracy.

In one embodiment, a confidence level is defined as the percentage of consumers whose accuracy is above certain level. For example, a confidence level of 90% accuracy means the percentage of consumers whose accuracy is 90% or higher. As such, a user of embodiments of the invention may request a report produced by embodiments of the invention having a minimum confidence level and a minimum accuracy level to meet the minimum level for further marketing analysis. The minimum confidence level gives a lower bound of the size of buckets; the size of buckets cannot decrease further from certain level or the number of buckets cannot increase indefinitely.

In one embodiment, defining buckets needs to take into account regulations from data providers. In one example, a provider predefines the scale of bucket dimensions (e.g., income: $0-$19,999, $20,000-$49,999, $50,000-$74,999, $75,000-$99,999, $100,000-$124,999, and $125,000 or more) so that users may not choose different scales. Thus, buckets are designed to be compatible with these predefined scales. In another example, a provider does not wish to send individual level data or acquirement of such data may not be compatible with local regulations, such as privacy regulations or laws. Instead, the provider agrees to send only aggregated data of at least n consumers, for a specific n>0, or to notify it if there are no consumers who match to requester's description. The buckets need to be defined so as to have at least n consumers each or to be empty. Consequently, each data source and/or media channel may have different bucket definitions.

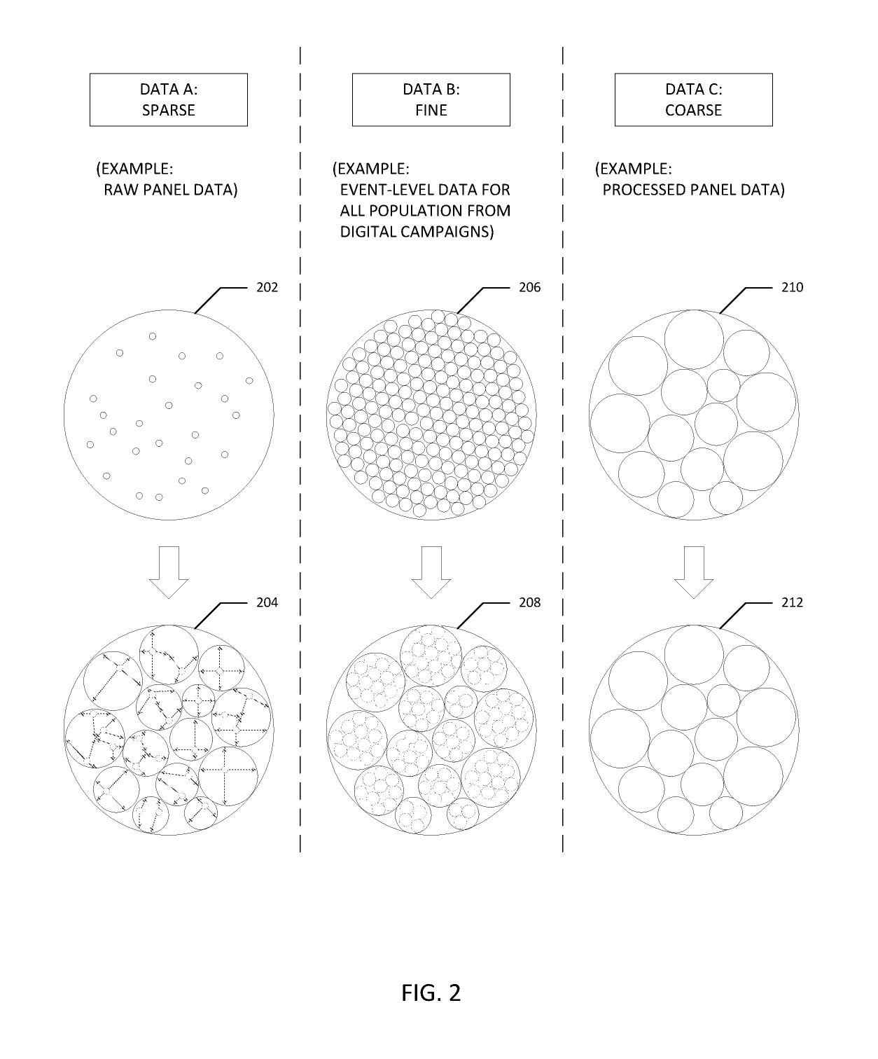

Before a UMIT is created, the bucket data from a plurality of sources and/or channels needs to be unified so that their buckets are consistent with each other (block 108). FIG. 2 shows an example of datasets with different granularity, 202, 204, and 206, and an illustration of fitting them into the same set of buckets. In one example, there may be a sparse data, such as panel data, that has a few panelists per buckets even though the buckets have much more consumers (202). In other words, only a small portion of consumers, who have agreed to be a panel, are observed. Since most other consumers are unknown, the panel data of each bucket needs to be extrapolated to represent the entire consumers belonging to the bucket (204). In one embodiment, the extrapolation may be done by a statistical inference method known to a person skilled in the art. In another example, the buckets of a data source (206) may be finer than those of another data source (210). Then, the buckets of the former are regrouped to larger buckets and/or the buckets of the latter are interpolated to smaller buckets to be consistent with the former. A skilled person in the art may similarly develop the required interpolation method to be used in conjunction with the invention without departing from the scope or spirit of the invention. In one embodiment, one may build a statistical method based on distribution of population in terms of demographic information, which may be obtained from census records or third-party survey data.

After this step, all datasets should have identical bucket definitions and are ready to be correlated or stitched. In one example, correlating or stitching data (block 110) is executed for each individual bucket. In another example, the stitching task may simply mean combining all data for the same bucket or include additional processes, such as deploying the data in chronological order across multiple channels. A person skilled in the art may develop an alternative version of the UMIT. The unified data may then be used for a plurality of analysis and modeling purposes where there is a need for modeling data points across multiple advertising channels (block 114). In one embodiment, the UMIT refers to a standard table that contains the information of all activities of each bucket through all observable marketing channels.

It is to be understood that creation of the UMIT is more than a simple data gathering process, however complex. The creation of the UMIT requires the recognition of the data structural information as well as potential usage or analysis of the UMIT. For example, as explained above, an input data 1 source may include data of a large number of users without any identifying information to each individual. However, in creating or building the buckets for the UMIT, other relevant information is collected or integrated to make the bucket data meaningful for analysis. The relevant information may have different information value weights that may affect how the bucket data may be analyzed and used.

Since each modeling and analysis approach has its own requirement and specific data format (block 112), in most cases there will be need for converting the unified data table to a model-specific format.

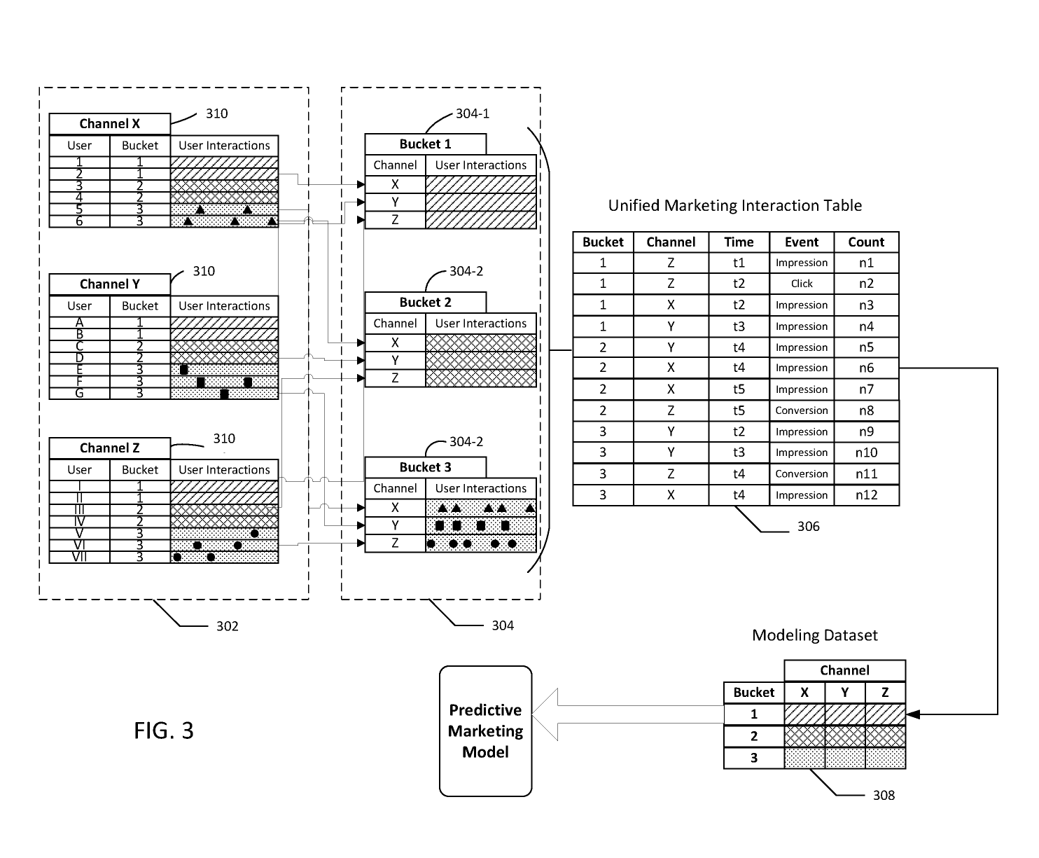

FIG. 3 is a schematic illustration of the data format evolving through the integration process with three channels 310 and three buckets 304 according to one embodiment of the invention. For each of X, Y, and Z channels 310 in a collection 302, user IDs and their interactions with the corresponding channel are recorded. These different interactions are shown with different representations in FIG. 3. For example, FIG. 3 shows user interactions in channel X may be classified to at least three types: shading with a “/” style; shading with a patched pattern of “/” and “\” lines; and shading with dots and polygon shapes. It is to be understood that other types of representation of the user interaction may be used without departing from the scope or spirit of the invention.

The channels have different user ID scheme. After the user assignment step 106 in FIG. 1, these users are classified to one of the three predefined buckets (304). These pre-defined buckets 304 shown in FIG. 3 with bucket IDs—1, 2, and 3—are universal across all the channels so the same buckets of different channels may be merged together. Of course, one should not overlook the fact that the buckets are created to have such a universal feature. Aspects of the invention build this universality as the common denominator for the UMIT to create the interoperability to make the received data useful for analysis.

In one example, during the process of merging, for each channel, all interactions of users in the same bucket may be combined together. In another example, the users of bucket 3 made interactions with channels X, Y, and Z, which are depicted as small triangle, rectangle, and circle markers, respectively. The interaction data points, even any detail of the data such as timestamp, are not lost during the merging task but just combined and assigned to the corresponding bucket.

Next, based on one embodiment of the invention, an instance of the UMIT 306 is created. This UMIT is a standard dataset that keeps all attributes obtained from raw data. In one embodiment, the interactions are listed in terms of the bucket ID, channel ID, timestamp, event type, and the number of events. Other available attributes of the interactions may also tagged in the table even though they are not depicted in 306. Once UMIT is created, this UMIT becomes an input of a proper analytic method or is further customized for each analytic method. The customized table 308 may be called Modeling Dataset (MD).

In one application of embodiments of the invention, one many want to analyze contribution of each marketing channel to increase of sales. Based on this desirable goal, a modeling dataset (MD) may be created by summing the number of impression events across time for each bucket and each channel. More examples of various analytic methods are provided in details below.

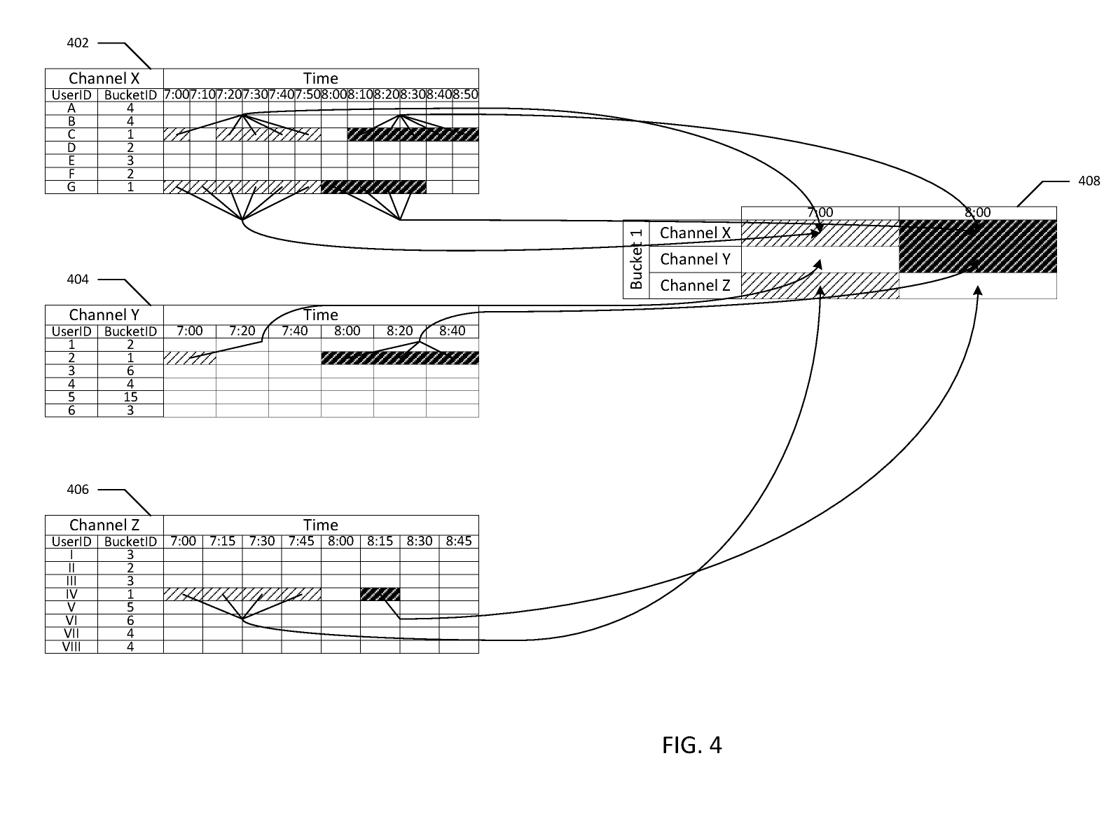

Combining data sources for each bucket may take into account different time level of the data. FIG. 4 are exemplary figures of integrating data with different level of time granularity. In this example, for the sake of simplicity and not limitation, three channels are used for illustrating embodiments of the invention. There are three channels and their users are already assigned to predefined buckets. Again, as described above, buckets may be defined based on various criteria or in response to user requirements. This example only focuses on the users assigned to the bucket with Bucket ID 1. The channel X records user interactions every 10 minutes (402) and the channel Y every 20 minutes (404), and channel Z every 15 minutes (406). Before combining the data, the time level of each channel data is adjusted to 60 minutes (408) and the data from channels X, Y, and Z are properly accumulated. In one embodiment, one may recognize an interaction only when the user had at least certain number of interactions or an interaction for at least certain amount of time within the time level. On one hand, in the channel Z, the user interaction which have happened within just 15 minutes between 8 and 9 o'clock is ignored during the time level adjustment because the amount of the interaction is not significant enough. On the other hand, users have interaction with media through the channel X longer than 30 minutes between 8 and 9 o'clock; their interactions are fully recognized. This example adjusts the time level to 60 minutes, which is the least common multiple of the original time levels, 10, 15, and 20. However, any time level may be used by a person skilled in the art.

UMIT can be further processed to create Modeling Datasets (MD) for a plurality of analysis and modeling purposes. This may include but not limited to path-to-conversion analysis, marketing mix modeling, attribution modeling and agent-based modeling. A skilled person in the art may come up with other potential use cases for UMIT.

In one application, one may use UMIT for path-to-conversion analysis. This type of analysis gives marketers a deep insight into consumers experience before conversion. For example, one can calculate the number, time, and order of impressions before conversion for each segment of the population. In one embodiment, a path-to-conversion is analyzed in bucket level, treating one bucket as one consumer. Accordingly, the MD is created from the UMIT by fusing interactions of consumers in a bucket. The fusing task may perform decision making of whether the amount of each kind of interactions is significant. Then the number or time length of interactions will be mapped to a binary value that indicates whether the interaction is significant enough to be recognized or small enough to be discarded. Also, not only the number of interactions but also the time of interactions may need to be fused. This may be illustrated in a table 410. Some channels serve impressions to consumers any time during a day and it is important to pick a reasonable representative time when the fused impressions should be considered to happen. The path-to-conversion analysis can identify the users' experiences that are most likely lead consumers to convert as defined by a marketing campaign—e.g., purchase a product.

In another application, one may use the UMIT for attribution modeling. Attribution modeling aims at finding the effectiveness and contribution of each marketing interaction for driving conversion. For this type of analysis one should create a table with number of impressions from each channel per bucket as the independent variables. On the other hand, the probability of conversion among each bucket's members may be considered as dependent variable. The produced MD can then be used as data points for training a plurality of models. The outcome of these models may be used for measuring the impact of each channel in driving the conversion. A person skilled in the art may develop a proper method to be used as attribution modeling tool.

In another application, one may use the UMIT for marketing mix modeling (MMM) and consumer mix modeling (CMM). This type of model may be used to build a predictive model for future sales based on the plurality of factors including media impressions as well as non-advertising activities including, but not limited to, trade, promotion, seasonality, and weather factor. In one embodiment of marketing mix modeling, the MD may be similar to the one used for attribution modeling. In some cases, instead of considering all buckets as independent data points, one may aggregate data from multiple buckets based on plurality of bucketing dimensions. A person skilled in the art can customize MD according to variations of marketing mix modeling.

In another application, one may use the UMIT for agent-based modeling. The agent-based modeling defines each consumer's characteristic and simulates various marketing strategies to observe the consumers' behaviors as a whole. Thus, it requires the information of consumers' interaction with a plurality of media channels. In one embodiment, the MD created for the path-to-conversion analysis can be used in an agent-based model that treats each bucket as one consumer. In another embodiment, an MD may have a plurality of consumers per bucket, whom are chosen so that the consumers' marketing interactions statistically well represent the whole interactions of the bucket. This MD may enable an agent-based model to create and simulate much more consumers than the number of buckets.

What makes UMIT overcoming shortfalls of the prior art is that cross-channel advertising campaigns may be analyzed as a whole or in its entirety using UMIT. By using UMIT, cross-channel campaigns may be analyzed without losing much individual details depending on how finely the buckets are defined. The capability of pseudo-individual level cross-channel analysis helps advertisers find the best way to target individual consumers utilizing multiple channels. It helps them overcome challenges of losing individual details while doing a cross-channel analysis or looking into all channels together while doing an individual-level analysis. The former challenge can happen in a marketing mix modeling while the latter happens in path-to-conversion or attribution modeling.

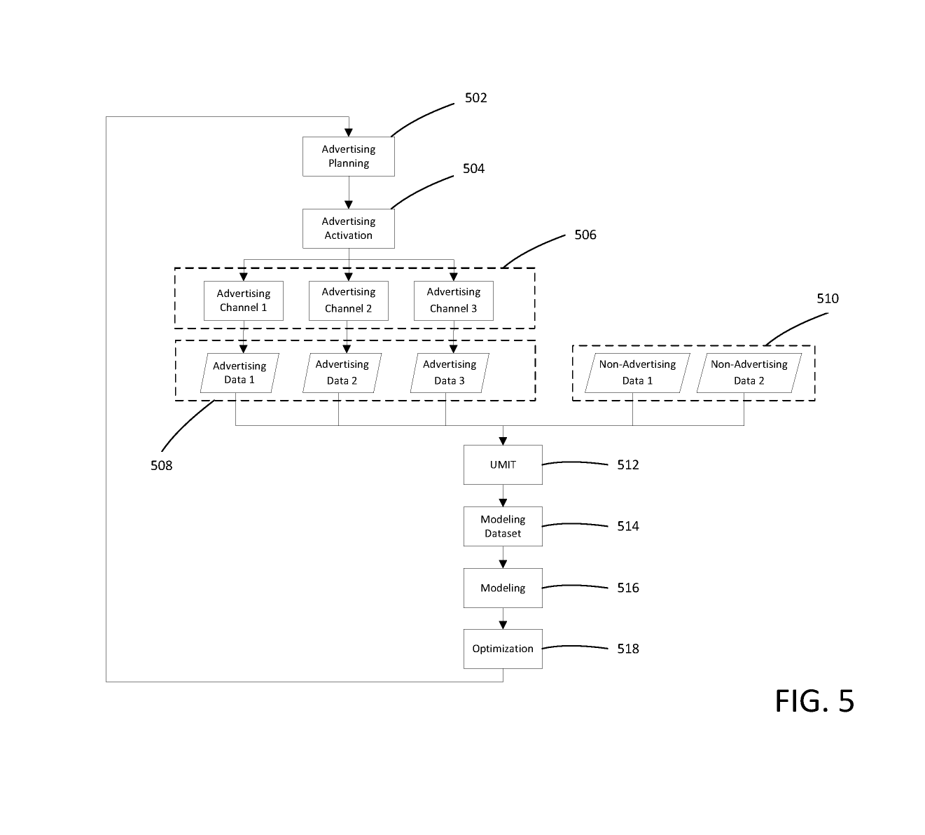

In one embodiment, measurement and activation steps follow a flowchart depicted in FIG. 5. In one example, an advertiser runs one or plural cross-channel advertising campaigns via TV commercials, online direct banners, and social media marketing 506 based on a set of initial advertising planning 502 and an advertising activation 504. In the middle of the campaigns or after the campaigns end, marketing activity data 508 recorded throughout the campaigns are unified through the system depicted in FIG. 1 and UMIT 512 is constructed from it.

Non-advertising data 510 or data not collected from the advertising campaigns, such as consumer survey data about product satisfaction or media consumption habit, may also be inserted into the system to construct the UMIT 512. The UMIT 512 is transformed to a modeling dataset 514 and entered to the modeling stage 516. An analytic model is fitted to the modeling dataset so as to best predict key performance indicators (KPIs) in terms of campaign parameters. Once the model is fitted, it can be used for the advertiser to find optimal campaign parameters 518 that maximize the KPIs. As the last step, the advertiser takes the optimized parameters into account when they plan future campaigns or modify currently running campaigns 502 and activate optimally designed plan 504. In this step, they reach audiences who are identified in the optimization step 518 and planned in the planning step 502 through channels with relevant inventories which again are identified in the steps 518 and 502. After the new or modified campaigns are executed at the activation stage 504, data is again gathered and unified in a similar manner to repeat the aforementioned process.

In one embodiment, the modeling 516 may be an attribution model that measures contributions of each of TV commercials, online direct banners, and social media marketing to each consumer's purchase in the campaigns. Then the optimization 518 may be done about the most effective media to deliver ads to each consumer and the planning 502 may comprise customizing the way of advertising to each individual consumers.

In another embodiment, the modeling 516 uses an agent-based model that captures how ads go viral on social media. Then the optimization 518 may comprise finding opinion leaders on a social network and the planning 502 and the activation 504 comprise targeting those opinion leaders.

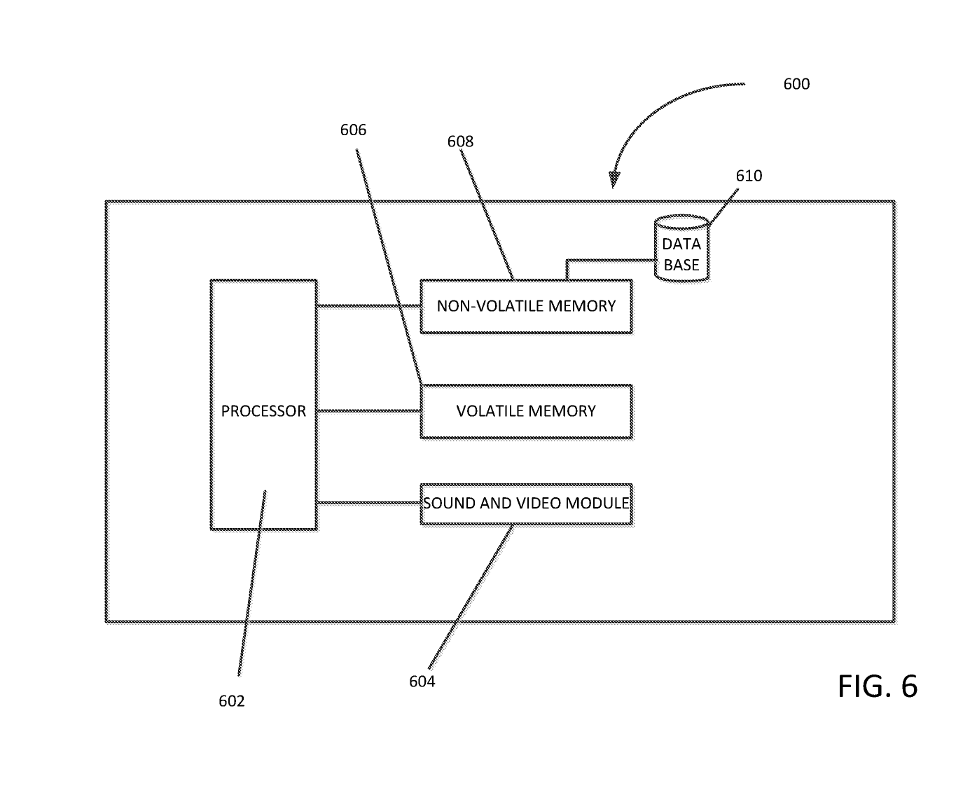

Referring now to FIG. 6, a system diagram illustrating a typical computing system environment 600 for executing and implementing embodiments of the invention. The computing system environment 600 may include a digital storage such as a magnetic disk, an optical disk, flash storage, non-volatile storage, etc. Structured data may be stored in the digital storage such as in a database. The computing system 600 may include a computing device, such as a server, a personal computer, etc., with a processor 602. In one embodiment, where the computing system 600 includes multiple computing devices connected. In one embodiment, the computing system includes the processor 602 that is physically configured according to computer executable instructions. The computing system environment 600 may also have volatile memory 606 and non-volatile memory 608.

The database 610 may be stored in the memory or may be separate. The database 610 may also be part of a cloud of computing system 600 and may be stored in a distributed manner across a plurality of computing system 600. For example, it may be appreciated that the UMIT and/or buckets may be stored in the database 610. There also may be an input/output bus 612 that shuttles data to and from the various user input devices such as a microphone, a camera, inputs such as an input pad, a display, and the speakers, etc. The input/output bus 612 also may control of communicating with the networks, either through wireless or wired devices. In some embodiments, the application may be on the local computing system 600 and in other embodiments, the application may be remote. Of course, this is just one embodiment of the computer system 600 and the number and types of portable computing system 600 is limited only by the imagination.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

For example, programming codes or routines based on the following pseudo-codes may be executed to implement aspects of the invention:
DEFINE advertising data source=data1;
DEFINE non-advertising data source=data2;
DEFINE bucket specification;
FOR data IN [data1, data2] {
Collect data elements from data1 and data2;
Format collected data elements according to the bucket specification to one or more buckets;
Identify data points from the buckets;}
DEFINE unified marketing interaction table=UMIT;
Construct UMIT by correlating or stitching data from the buckets;
DEFINE modeling attributes=attributes;
DEFINE modeling dataset=dataset;
FOR data IN UMIT{
Compare data with the attributes;
Construct dataset based on the comparison;}
Display the constructed dataset to the user;

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving systems providing more accurate data analysis and to better harvest data points from data sources. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A computerized method for integrating activity data comprising:
obtaining a plurality of activity data of the consumer data points with data channels from different data sources, wherein the obtained plurality of activity data comprises non-uniformed data formats and with data properties based on a plurality of data property definitions;
determining a set of data buckets;
classifying each of the plurality of activity data into the determined data buckets, wherein classifying reorganizes each of the plurality of activity data;
stitching the plurality of activity data in the determined set of data buckets, wherein stitching creates a unified marketing interaction table (UMIT); and
creating a unified marketing interaction table (UMIT) for analysis on the data properties of the stitched plurality of activity data.

2. The computerized method of claim 1, wherein activity comprise advertising activities conducted in one or plurality of media including, but not limited to, television, radio, newspaper, display, search engine, billboard, transit, mobile, and social networks.

3. The computerized method of claim 1, wherein activity comprises one or more of the following:
non-advertising activity including, but not limited to, trade, promotion, seasonality, and weather factor;
an advertising campaign; and a plurality of campaigns for a particular advertiser or a plurality of advertisers.

4. The computerized method of claim 1, wherein the plurality of activity data comprises media consumption data, consumer data, data from online and offline sales.

5. The computerized method of claim 1, wherein the data buckets comprises a set of data organization representing a group of people who share the common features in at least one of the following attributes: age, gender, ethnicity, annual income, household size, education level, occupation, geographical information, or any other attributes.

6. The computerized method of claim 1, wherein determining the set of data buckets comprises defining dimensions of the set of data buckets and adjusting a granularity level of these dimensions to meet a desired size or number of the set of data buckets to ensure a desired accuracy in response to different granularity levels of the different data sources.

7. The computerized method of claim 6, wherein a size of the set of data buckets comprises a size between one individual and the global population.

8. The computerized method of claim 6, wherein adjusting the level of granularity comprises unifying different coarseness levels and different sparsity levels of the different data sources, wherein the different data sources comprise at least one of the following: online individual level activity data, panel activity data, and survey activity data, or any other activity data.

9. The computerized method of claim 1, where stitching the activity data comprises at least one of the following: maintaining the activity data in an original format and organizing the activity data differently to make data in the same set of data buckets compatible across all channels.

10. The computerized method of claim 1, wherein stitching the plurality of activity data comprises adjusting time granularity from the different data sources.

11. The computerized method of claim 1, wherein the UMIT is an input to applications as is or transformed to create Modeling Dataset (MD) as an input to applications.

12. The computerized method of claim 11, wherein creating the modeling dataset comprises creating the modeling dataset for customized operations including at least one of the following: grouping, counting, filtering, pivoting, or any other data processing step.

13. The computerized method of claim 11, wherein the application comprises comprehensive analyses of the unified activity data on a basis of the set of data buckets, media-by-media basis, monthly basis, or any other level of granularity on any possible dimension.

14. The computerized method of claim 13, wherein the application comprises a path-to-conversion modeling to understand a path for each customer to purchase and to compare contributions of marketing channels.

15. The computerized method of claim 13, wherein the application comprises an attribution modeling for distribution of marketing performance among plurality of advertising attributes including advertising media, like TV and digital, and seasonality

16. The computerized method of claim 13, wherein the application comprises a marketing mix modeling in which a plurality of advertising attributes and environmental factors are used to predict a marketing campaign performance.

17. The computerized method of claim 13, wherein the application comprises an agent-based modeling in which each agent represents another set of data buckets and actions of the agent are determined by the marketing activity data of the another set of data buckets.

18. The computerized method of claim 13, wherein outcomes of the analyses of the unified activity data can be used to reach audiences by planning and activating one or plurality of advertising campaigns in one or plurality of media including, but not limited to, television, radio, newspaper, display, search engine, billboard, transit, mobile, and social networks.

19. A system for integrating activity data comprising:
a memory for storing data and processor-executable instructions;
a processor, accessing the memory, configured to access the stored data in the memory and configured to execute processor-executable instructions to:
obtain a plurality of activity data of the consumer data points with data channels from different data sources, wherein the obtained plurality of activity data comprises non-uniformed data formats and with data properties based on a plurality of data property definitions;
determine a set of data buckets;
classify each of the plurality of activity data into the determined data buckets, wherein the processor further reorganizes each of the plurality of activity data;
stitch the plurality of activity data in the determined set of data buckets, wherein the processor adjusts time granularity from the different data sources; and
create a unified marketing interaction table (UMIT) for analysis on the data properties of the stitched plurality of activity data, wherein the processor creates a modeling dataset that is customized to be an input of an application.

20. A computerized system for integrating activity data comprising:
a memory for storing data and processor-executable instructions;
a processor, accessing the memory, configured to access the stored data in the memory and configured to execute processor-executable instructions to:
obtain a plurality of activity data of the consumer data points with data channels from different data sources, wherein the obtained plurality of activity data comprises non-uniformed data formats and with data properties based on a plurality of data property definitions;
determine a set of data buckets;
classify each of the plurality of activity data into the determined data buckets, wherein the processor further reorganizes each of the plurality of activity data;
stitch the plurality of activity data in the determined set of data buckets; and
create a unified marketing interaction table (UMIT) for analysis on the data properties of the stitched plurality of activity data, wherein the processor creates a modeling dataset for customized operations including at least one of the following: grouping, counting, filtering, and pivoting, wherein the processor applies the created modeling dataset for future planning of collection of the plurality of activity data of the consumer data points with the data channels from the different data sources.
